(19) United States
(12) Patent Application Publication
(10) Pub. No.: US 2005/0181001 A1
(43) Pub. Date: Aug. 18, 2005

(54) Topical formulation for insect repellents

(76) Inventors: E. George Roentsch, Stoddard, NH (US); Matthew Buderer, Oak Harbor, OH (US); Peter R. Ford, Moncton (CA)

Correspondence Address: Origin BioMedicinals Inc., 5162 Duke Street, Suite 520, Halifax, NS, B3J 1N7, CA

(21) Appl. No.: 11/012,823

(22) Filed: Dec. 16, 2004

Related U.S. Application Data
(60) Provisional application No. 60/530,253, filed on Dec. 18, 2003.

(51) Int. Cl. A01N 43/78; A01N 25/00; A01N 37/18; A01N 35/00; A01N 65/00

(52) U.S. Cl. 424/405; 424/742; 424/745; 424/747; 424/750; 424/761; 514/276; 514/629; 424/778; 424/770; 514/699

(57) ABSTRACT

The present invention discloses a composition of matter useful for insect repellency, which is topically applied in the form of a spray, liquid, cream, gel, ointment or towelette comprising a B vitamin, and in particular vitamin B1 (thiamine) in any chemical form, as the sole active ingredient or in combination with other active ingredients known to provide insect repellency. Such thiamine component of a final formulation is particularly effective when thiamine concentrations exceed 0.01% w/v in the topical mixture, and its use is preferred when concentrations are between 0.01 to 30% w/v thiamine. Said formulation is increased in effectiveness for insect repellency when additional ingredients are also added which are also known to provide insect repellency.

### BACKGROUND TO THE INVENTION

Multiple species of flying and crawling insects, including mosquitoes, ticks, flies, midges, chiggers, and fleas bite people. While these insects are a nuisance, they can also poise a health risk by transmitting more than 100 bacterial, protozoan, parasitic, and rickettsial diseases to humans worldwide.

Mosquitoes transmit more diseases to humans than any other biting insect. Mosquitoes are the vectors responsible for transmitting several forms of viral encephalitis, malaria, yellow fever, dengue fever, bancroftian filariasis, West Nile virus and epidemic polyarthritis to humans. More than 700 million people are infected each year. Increasingly in North America, the West Nile virus is responsible for an increasing number of fatalities or prolonged illness.

Over the years, there has been a large demand for personal-use insecticides, both topically and orally administered. DEET (diethyl-m-toluamide) has been the most widely used active ingredient in topical insecticides for several decades. Recent reports, however, has highlighted the toxic nature of this compound, especially when applied at high concentrations or on young children.

Orally administered insect repellents are well known, but are not as effective as topically applied repellents, and may take several days of continuous use to become effective. Some studies suggest that taking thiamine (vitamin B1) at dosages of 25 to 50 mg three times per day is effective in reducing mosquito bites. This safe vitamin apparently produces a skin odor that is not detectable by humans, but is disagreeable to pregnant mosquitoes (1). Thiamine, however, can take up to 2 weeks before the odor fully saturates the skin and becomes effective. Garlic, brewer's yeast and other plant-based chemicals have also been reported to repel mosquitoes when taken orally. To date, the results of several scientific studies do not support the claims that these materials are effective repellents for mosquitoes or other biting insects, mites or ticks (2,3). Most alternatives to topically applied repellents have proved to be ineffective possibly because of an inability to achieve a high enough concentration at the surface of the skin.

Efforts have been made by a number of manufacturers to develop topically-applied repellents which provide a safe alternative to DEET, and are also safe and effective. Numerous “all-natural” plant-derived repellents have been tested, but most have not proven their effectiveness compared to DEET. These plant derived repellents are largely aromatic plant oils, including citronella, neem, vanilla, lemongrass, pennyroyal and eucalyptus.

Several other plant essential oils have been reported to have mosquito repellency at different concentrations, including Bourbon geranium, cedarwood, clove, peppermint, and thyme (4). Cedarwood oil failed to repel mosquitoes and only high concentrations of peppermint oil repelled Ae. aegypti. None of the oils tested prevented mosquito bite when used at the 5 or 10% concentration. Thyme and clove oils were the most effective mosquito repellents and provided 1½ to 3½ h of protection, depending on oil concentration. Clove oil (50%) combined with geranium oil (50%) or with thyme oil (50%) prevented biting by An. albimanus for 1¼ to 2½ h. The potential for using essential oils at these concentrations as topical mosquito repellents may be limited by user acceptability.

Researchers have reported that nepetalactone, the essential oil in catnip that gives the plant its characteristic odor, is more effective at repelling mosquitoes than DEET (5). A patent application for the use of catnip compounds as insect repellents was submitted by the Iowa State University Research Foundation.

There are no reports in the literature of topically applied vitamin B1 (thiamine), despite the potential usefulness of orally administered thiamine. One product contains a broad range of essential oil and catnip, as well as wheat germ oil. Wheat germ oil is known to contain a small concentration of natural vitamin B1 as thiamine chloride, but at concentrations that are too low for effectiveness.

The use of topical vitamin B1 (thiamine) may be an effective compound in the repellency of mosquitoes and other biting insects. Thiamine is an abundant, low cost, safe compound that can be easily stabilized in topical formulations. For this reason, it is important to devise a formulation by which an effective concentration of thiamine is utilized as the sole active ingredient or in combination with our ingredients known to provide insect repellency. A novel application for the use of topical thiamine as an insect repellent is described herein.

### REFERENCES CITED

1. Pediatric Clinics of North America, 16:191, 1969
2. N Engl J Med. Vol. 347, No. 1, page 16
3. Trans St Johns Hosp Dermatol Soc 1969;55:99-102
4. J Med Entomol. September 1999;36(5):625-9
5. American Chem. Soc. Press Release, 2001-08-28

### BRIEF SUMMARY OF THE INVENTION

The present invention discloses a composition of matter useful for insect repellency, which is topically applied in the form of a spray, liquid, cream, gel, ointment or towelette comprising vitamin B1 (thiamine) in the form of the hydrochloride salt, as the sole active ingredient or in combination with other active ingredients known to provide insect repellency.

Such topical thiamine component of a final formulation is particularly effective when thiamine concentrations exceed 0.01% w/v in the topical mixture, and its use is preferred when concentrations are between 0.1 to 30% w/v thiamine. Said formulation is increased in effectiveness for insect repellency when additional ingredients are also added which are also known to provide insect repellency.

### DETAILED DESCRIPTION OF THE INVENTION

The present invention discloses a composition of matter useful for insect repellency, which is topically applied in the form of a spray, liquid, cream, gel, ointment or towelette comprising vitamin B1 (thiamine) in the form of the hydrochloride salt, as the sole active ingredient or in combination with other active ingredients known to provide insect repellency. Other active ingredients may include, but are not limited to, DEET, citronella, neem, vanillin, lemongrass, pennyroyal, eucalyptus, Bourbon geranium, cedarwood, clove, peppermint thyme and catnip. Such a topically applied composition of matter for insect repellency comprising the use of thiamine in a concentration that exceeds 0.01% w/v is not readily obvious to one skilled in the art. Oral dosing of thiamine at 25 to 50 mg three times per day may be effective for insect repellency after at least one week, but the concentration produced by this systemic dose at the surface of the skin is not known. At least one product, Skram, recognizes the value of topical thiamine for insect repellent by adding wheat germ oil in the formulation. Wheat germ oil contains approximately 0.0002% w/w thiamine, thereby providing concentrations that are too low for effective insect repellency.

The thiamine component of a final topical formulation in the present invention is particularly effective when thiamine concentrations exceed 0.01% w/v in the topical mixture, and its use is preferred when concentrations are between 0.01 to 30% w/v thiamine. Said formulation is increased in effectiveness for insect repellency when additional ingredients are also added which are also known to provide insect repellency.

### EXAMPLE ONE

### ‘Skeeter Beater’

A preparation an insect repellent consisting of 5% w/v thiamine has been devised which utilizes other known insect repellency ingredients in a suitable base as follows:
5% Thiamine Hydrochloride
1% Vanillin, NF
1% Zinc Sulfate
1% Peppermint Oil

In order to test the efficacy of insect repellency at the concentration of thiamine in this ‘Skeeter Beater’ formulation, tests were conducted on approximately 100 subjects who were exposed to mosquitoes and other biting insects. Results indicated that the majority of subjects reported only 2-3 mosquito bites for an average of 8 hours after topical application to the exposed skin while in the presence of heavy infestations of mosquitoes, which is significantly less that untreated subjects.

### EXAMPLE TWO

### ‘Gub Lotion’

A separate preparation of an insect repellent consisting of 5% w/v thiamine has been devised as follows:
5% Thiamine Hydrochloride
1% Vanillin, NF
1% Ascorbic Acid

In order to test the efficacy of insect repellency in this ‘Gub Lotion’ formulation, tests were conducted on approximately 100 subjects who were exposed to mosquitoes and other biting insects. Results indicated that the majority of subjects reported 3-4 mosquito bites for an average of 8 hours after topical application to the exposed skin, which is substantially less than untreated control subjects. Stability of the finished product was compromised by the ascorbic acid, which oxidized over short periods of time and turned the final product dark brown to black.

The present invention clearly describes the necessary concentration of thiamine in a final topical formulation as being is particularly effective when thiamine concentrations exceed 0.01% w/v in the topical mixture, and its use is preferred when concentrations are between 0.01 to 30% w/v thiamine. Said formulation is increased in effectiveness for insect repellency when additional ingredients are also added which are also known to provide insect repellency.

Although the present invention has been described in detail with particular reference to referred embodiments thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure and description are for illustrative purposes only, and do not in any way limit the invention, which is defined only by the claims.

1. A composition of matter consisting of a suitable topical formulation for use in repelling insects in the form of a spray, liquid, cream, gel, ointment or towelette, comprising a B vitamin as the sole active ingredient or in combination with other active ingredients known to provide insect repellency.

2. According to claim 1, a composition of matter consisting of a suitable topical formulation for use in repelling insects in which the B vitamin is vitamin B1 (thiamine) in any chemical form.

3. According to claim 2, a composition of matter consisting of a suitable topical formulation for use in repelling insects containing vitamin B1 (thiamine) in a concentration greater than 0.01% w/v.

4. According to claim 3, a composition of matter consisting of a suitable topical formulation for use in repelling insects containing vitamin B1 (thiamine) in a concentration between 0.01% and 30% w/v.

5. According to claim 1, a topically applied composition of matter useful for insect repellency comprising a B vitamin in combination with other active ingredients known to provide insect repellency, including but not limited to DEET, citronella, neem, vanilla, lemongrass, pennyroyal, eucalyptus, Bourbon geranium, cedarwood, clove, peppermint thyme and catnip.
